(19) United States
(12) Patent Application Publication
(10) Pub. No.: US 2012/0225635 A1
(43) Pub. Date: Sep. 6, 2012

(54) METHOD AND APPARATUS TO TAKE EMERGENCY ACTIONS WHEN A DEVICE IS SHAKEN RAPIDLY BY ITS USER

(75) Inventor: Daniel Esbensen, Blue Diamond, NV (US)

(73) Assignee: Touch Technologies, Inc., San Diego, CA (US)

(21) Appl. No.: 13/337,323

(22) Filed: Dec. 27, 2011

Related U.S. Application Data
(60) Provisional application No. 61/427,173, filed on Dec. 24, 2010.

(51) Int. Cl. H04W 4/22; H04W 4/02

(52) U.S. Cl. 455/404.2; 455/404.1

(57) ABSTRACT

Methods and systems for using a portable device with communication capability and motion detection to act as an emergency alert system by detecting shaking of the device and taking appropriate actions are disclosed. The portable device may take independent action such as calling a telephone number or sending a message when the shaking alert is activated. The portable device may also communicate with an emergency alert server to take various configured emergency actions in response to a shaking event.

### CROSS REFERENCE TO RELATED APPLICATIONS

This application claims benefit of priority from provisional application 61/427,173 filed 24 Dec. 2010.

The above referenced documents and application and all documents referenced therein are incorporated in by reference for all purposes.

This application may be related to other patent applications and issued patents assigned to the assignee indicated above. These applications and issued patents are incorporated herein by reference to the extent allowed under applicable law.

PRECAUTIONARY REQUEST TO FILE AN INTERNATIONAL APPLICATION, DESIGNATION OF ALL STATES, AND STATEMENT THAT AT LEAST ONE APPLICANT IS A UNITED STATES RESIDENT OR ENTITY

Should this document be filed electronically or in paper according to any procedure indicating an international application, Applicant hereby requests the filing of an international application and designation of all states. For purposes of this international filing, all inventors listed on a cover page or any other document filed herewith are applicants for purposes of United States National Stage filing. For purposes of this international filing, any assignees listed on a cover page or any other document filed herewith are applicants for purposes of non-United States national stage filing, or, if no assignee is listed, all inventors listed are applicants for purposes of non-United States national stage filing. For purposes of any international filing, applicants state that at least one applicant is a United States resident or United States institution. Should this application be filed in as a national application in the United States, this paragraph shall be disregarded.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### APPENDIX

This application is being filed with an electronic source code appendix. This appendix and all other papers filed herewith, including papers filed in any attached Information Disclosure Statement (IDS), are incorporated herein by reference. The appendix contains further examples and information related to various embodiments of the invention at various stages of development. The appendix sets out selected source code extracts from a copyrighted software program, owned by the assignee of this patent document, which may aid in understanding examples related to the invention.

Permission is granted to make copies of the appendices solely in connection with the making of facsimile copies of this patent document in accordance with applicable law; all other rights are reserved, and all other reproduction, distribution, creation of derivative works based on the contents, public display, and public performance of the appendix or any part thereof are prohibited by the copyright laws.

### FIELD OF THE INVENTION

The present invention relates to use of portable electronic devices and emergency situations.

The present invention relates to a method and/or system and/or apparatus for providing enhanced services using portable electronic communicating devices. In specific embodiments, the invention involves a method and/or system and/or apparatus for providing an emergency service or other services activitated when a device is shaken or otherwise moved in a defined manner. In further embodiments, the invention involves one or methods that may be implemented on a data handling device or system, such as a portable information device or phone or smartphone. In further embodiments, the invention involves methods and/or systems for communicating various emergency actions or other actions over a communication network. In further embodiments, the invention involves methods and/or systems for providing associated services, such as providing a device that is better able to distinguish between genuine intended emergency movements and other movements, etc.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

Use of digital devices and applications is increasingly involving Application-centric computing platforms and mobile operating systems. Application-centric computing platforms manage their contained applications with generally much higher levels of control than in previous computer operating systems such as Microsoft Windows™, MacOS™, Linux™, etc.). Applications-centric platforms generally provide standardized interfaces for querying for the presence of applications that meet specific criteria and for communicating with applications individually.

Android™ is a mobile operating system based upon a modified version of the Linux kernel and currently managed by the Android Open Source Project. Android OS is widely available on smartphones and increasingly available on tablet and other personal computers. Microsoft Windows Mobile™ OS, Blackberry™ OS, and Apple's iPhone OS are other operating systems with some aspects of application centric design.

Android, as one example, has a large community of developers writing application programs (“apps”) that extend the functionality of the devices. Android Market™ is an online app store run by Google™, though apps can be downloaded from third party sites. Developers generally write in the Java language, using Google-developed Java libraries. As one example, the Android operating system software stack consists of Java applications running on a Java based object oriented application framework on top of Java core libraries running on a virtual machine featuring just-in-time (JIT) compilation. Libraries written in C include the surface manager, OpenCore media framework, SQLite relational database management system, OpenGL ES 2.0 3D graphics API, WebKit layout engine, SGL graphics engine, SSL, and Bionic libc. The Android operating system includes XML, C, Java, and C++. Windows Mobile, Apple iPhone OS, and other mobile platforms have different implementations.

Various strategies have been proposed for allowing a user to input some type of information or intention into a generally handheld electronic device using some type of motion activation. The field of smart phone applications is relatively young and yet extensive and well developed. Some relevant background data on smartphone applications and software development therefore and motion detection are discussed in the below indicated United States patents and patent applications:

| Patent or | | | |
|---|---|---|---|
| Application | | Publication | |
| Number | Title | Date | Filing Date |
| 20090082065 | Stand Alone Emergency Signal Device Housed | 2009-03-26 | 2007-09-21 |
| | In Cell Phone | | |
| 20100330952 | Personal Safety Device, System and Process | 2010-12-30 | 2010-06-25 |
| 20110059719 | Wireless Emergency Call Device | 2011-03-10 | 2009-09-08 |
| 20110195699 | Controlling Mobile Device Functions | 2011-08-11 | 2011-04-20 |
| 20110279263 | Event Detection | 2011-11-17 | 2010-05-13 |
| 6,292,674 | One-handed control for wireless telephone | 2001-09-18 | 1998-08-05 |
| 6,529,144 | Method and apparatus for motion activated | 2003-03-04 | 2000-09-22 |
| | control of an electronic device | | |
| 6,549,792 | Accelerometer influenced communication | 2003-04-15 | 1999-06-25 |
| | device | | |
| 6,636,732 | Emergency phone with single-button activation | 2003-10-21 | 2000-03-29 |
| 7,092,695 | Emergency phone with alternate number calling | 2006-08-15 | 2000-10-10 |
| | capability | | |
| 7,187,952 | Method of accepting a phone call based on | 2007-03-06 | 2005-03-07 |
| | motion properties of the phone and related | | |
| | device | | |
| 7,190,263 | Utilizing a portable electronic device to detect | 2007-03-13 | 2004-09-20 |
| | motion | | |
| 7,271,795 | Intuitive mobile device interface to virtual | 2007-09-18 | 2003-06-30 |
| | spaces | | |
| 7,679,604 | Method and apparatus for controlling a | 2010-03-16 | 2006-07-31 |
| | computer system | | |
| 7,711,349 | Apparatus, and associated method, for | 2010-05-04 | 2006-04-24 |
| | generating an alert to notify emergency | | |
| | personnel of a vehicular emergency | | |
| 7,853,240 | Emergency number selection for mobile | 2010-12-14 | 2007-02-15 |
| | communications device | | |
| 7,920,891 | Stand alone emergency signal device housed in | 2011-04-05 | 2007-09-21 |
| | cell phone | | |
| 8,018,435 | Method and apparatus for controlling a | 2011-09-13 | 2004-12-15 |
| | computing system | | |
| 8,081,351 | Mobile phone handset | 2011-12-20 | 2008-08-12 |

These document are incorporated herein by reference for all purposes.

### SUMMARY

According to specific embodiments, the present invention is involved with methods and/or systems and/or devices that can be used together or independently to provide an emergency response using a handheld device with motion detection through a shaking action.

In specific embodiments, the present invention can be understood as involving new business methods related to providing an emergency response service using servers and communicating devices as described herein.

Various embodiments of the present invention provide methods and/or systems for providing emergency services over a communications network. In specific embodiments of the invention, a client system or portable device system such as a smart phone is provided with one or more logic modules that detect certain user actions and optionally other device states as described herein that allow the device to take one or more actions related to user safety in an emergency situation.

As described herein, in response to a user input or action or indication, the portable device can optionally sends to a emergency server system necessary information to activate or access various emergency actions. The server system uses the received data, and optionally one or more sets of server data, to process the request.

Thus, in further embodiments, the present invention may be understood in the context of providing various alert services over a communication media. An important application for the present invention, and an independent embodiment, is in the field of providing text or other messages over the Internet or over a mobile telephone system, optionally using Internet media protocols and formats, such as JAVA, HTTP, RTTP, XML, HTML, dHTML, VRML, as well as image, audio, or video formats etc. However, using the teachings provided herein, it will be understood by those of skill in the art that the methods and apparatus of the present invention could be advantageously used in other related situations where users access content over a communication channel, such as institution network systems, wireless systems, etc.

### Software Implementations

Various embodiments of the present invention provide methods and/or systems as described herein that can be implemented on various information processing equipment, such as a smart phone or a general purpose or special purpose information handling appliance using a suitable programming language such as Java, C++, Cobol, C, Pascal, Fortran, PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

### Other Features & Benefits

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and equivalents.

Furthermore, it is well known in the art that devices, logic systems, logic modules, web interfaces, and various methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, etc. Furthermore, in some aspects, the present invention is described in terms of client/server systems. A number of computing systems and computing architectures are described in the art as client/server art. For the purposes of this description, client/server should be understood to include any architecture or configuration wherein an element acting as a client accesses a remote and/or separate program or device that is providing the desired service (e.g., a server).

Thus, before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

### BRIEF DESCRIPTION OF THE DRAWINGS

FIG. 1 illustrates an example graphical user interface showing login in order to access settings and/or emergency alert information according to specific embodiments of the invention.

FIG. 2 illustrates an example graphical user interface showing an overview of an integrated family safety system according to specific embodiments of the invention.

FIG. 3 illustrates an example graphical user interface showing an example of registering a phone with a server over a website according to specific embodiments of the invention.

FIG. 4 is a diagram illustrating an elderly user employing a shake alert motion according to specific embodiments of the present invention.

FIG. 5 illustrates an example graphical user interface showing an example graphic rich message or email indicating an alert according to specific embodiments of the invention.

FIG. 6 illustrates an optional example graphical user interface allowing a user to register one or more numbers to be alerted to certain communications on registered phones according to specific embodiments of the invention.

FIG. 7 is a block diagram showing a representative example logic device in which various aspects of the present invention may be embodied, in particular aspects related to registering or deploying an emergency alert server.

### DESCRIPTION OF SPECIFIC EMBODIMENTS

Before describing the present invention in detail, it is to be understood that this invention is not limited to particular compositions, devices, systems, or methods, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

Unless defined otherwise, technical and scientific terms used herein have meanings as commonly understood by one of ordinary skill in the art to which the invention pertains. Although any methods and materials similar or equivalent to those described herein can be used in practice or for testing of the present invention, the preferred materials and methods are described herein.

### DETAILED DESCRIPTION

Many Smartphones and other portable or moveable information devices now include accelerometer sensors. These devices also generally have a means to communicate to devices outside of themselves, such as other telephones or servers. The present invention involves a device that has both one or more accelerometer sensors and one or more transmission mechanisms for sending a communication signal to a system physically separate from the portable device—such as a Smartphone that has Internet access or mobile telephone access.

According to specific embodiments of the present invention, a device is configured so that if a user of the device is in trouble, the user can shake the device (e.g., rapidly back and forth or in some other motion) for some number of seconds. According to specific embodiments of the invention, the movement (e.g., continuous back and forth shaking) is detected as lasting more than a threshold time period and this triggers an event. An event listening process inside the Smartphone or similar device listens for the SHAKE event. When the event occurs, the listener wakes up and sends a message to an external device, such as a server. The message can contain information such as the name and phone number of the device, the location of the device, the device's battery level, and the devices capabilities.

The server, which can be any system able to execute logic commands, receives the message and looks at a RULES TABLE that defines actions for the server to take. The server then takes the defined actions. These actions might include calling the police, emailing a list of people with the date and time and location of the Smartphone. They might include sending a response message back to the Smartphone, asking the Smartphone to call a certain phone number, or to turn on the Smartphone' s microphone and recording ambient sound. Decisions can also be made based on the Smartphone's battery level—such as if the battery is full to send streaming audio and video to a server for storage—or to store the audio and video onto the Smartphone's internal storage device. One or more of the options can also be made by commands stored on the Smartphone.

Below is a summary of one example of how the shaking of the device can be detected in a way that reduces the chance of false detection of SHAKE EVENTS.

According to specific embodiments of the invention, shake detection provides a better means of indicating an alert situation because shaking can be quickly and easily accomplished in emergency situations, such as when a user is fleeing a potential threat, when a user is hurt or dazed or otherwise in a situation where it is not easy to manipulate the fine control mechanisms of the device. In many situations, according to specific embodiments of the invention, shaking can be activated more quickly, in more situations, and with less chance of a false detection than other alert methods, such as dialing a number.

Methods and systems of the invention have applications beyond the specific examples provided herein. Such applications include information components integrated into other information mobile systems or machines, such as a smart watch, tablet computer, camera, handbag, etc. While aspects and implementations of the invention will vary according to particular applications (e.g., audio-centric devices, versus visual-centric devices, such as a tablet PC, that may have only optional or limited audio input or output), the invention is best-described and understood by considering specific example applications. These example applications are taken primarily from the field of smart phones, though any other information system having characteristics as described in the claims in also intended.

When used herein, “the invention” should be understood to indicate one or more specific embodiments of the invention.

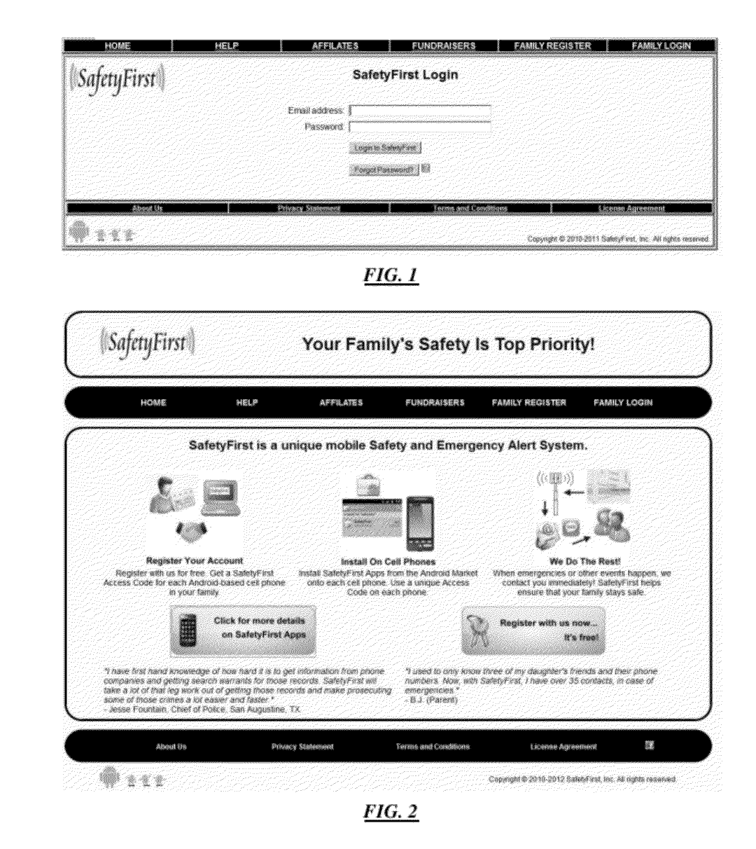

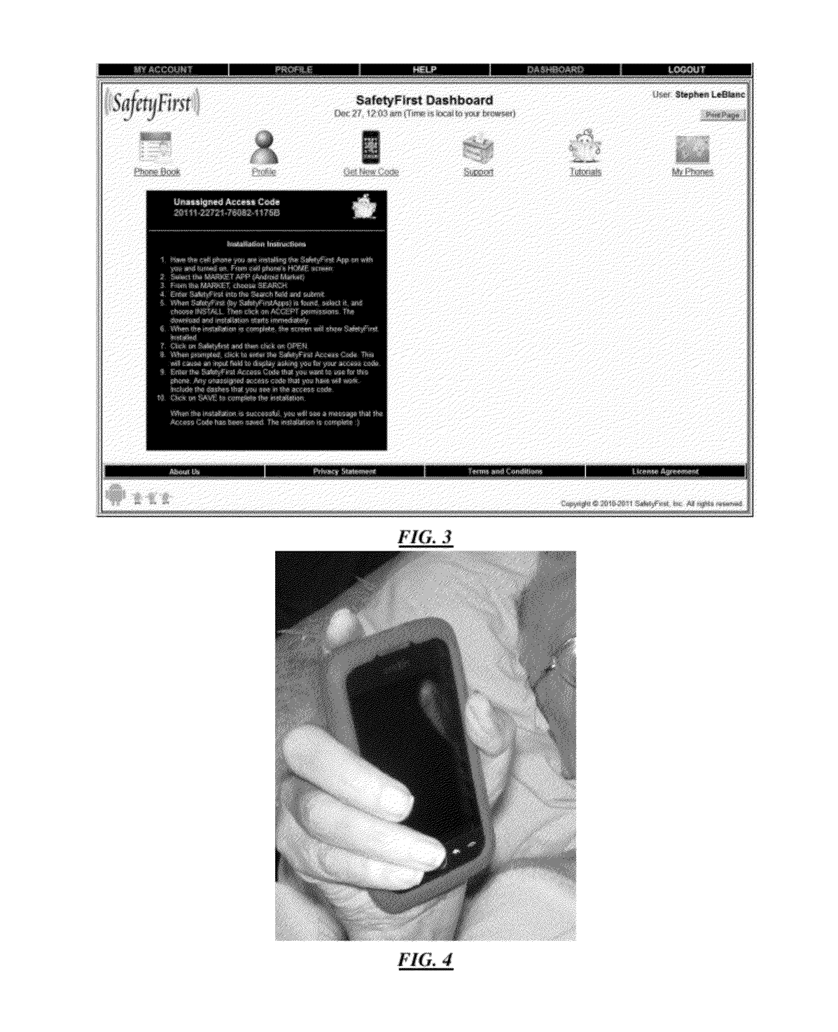

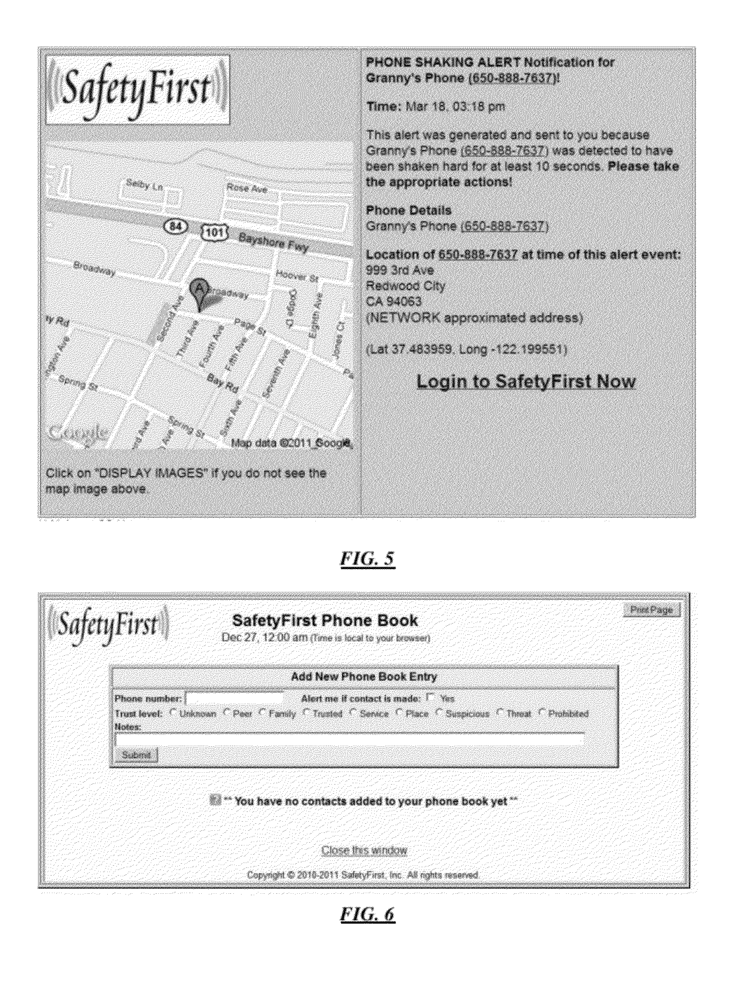

The invention and various specific aspects and embodiments will be better understood with reference to the following drawings and detailed descriptions. In some of the drawings and detailed descriptions below, the present invention is described in terms of the The SafetyFirst™ Service FIG. 1 illustrates an example graphical user interface showing login in order to access settings and/or emergency alert information according to specific embodiments of the invention. FIG. 2 illustrates an example graphical user interface showing an overview of an integrated family safety system according to specific embodiments of the invention. FIG. 3 illustrates an example graphical user interface showing an example of registering a phone with a server over a website according to specific embodiments of the invention. FIG. 4 is a diagram illustrating an elderly user employing a shake alert motion according to specific embodiments of the present invention. FIG. 5 illustrates an example graphical user interface showing an example graphic rich message or email indicating an alert according to specific embodiments of the invention.

According to specific embodiments of the invention, the invention in involved with a comprehensive service at times referred to as SafetyFirst™. The SafetyFirst™ service is directed to a simple goal—keeping families safe! The SafetyFirst service and software as discussed herein in specific embodiments turn a child's cell phone into an Emergency Alert System and optionally also include SafetyTrack™ tracking features, with parent selectable levels of tracking. The SafetyFirst service includes the unique emergency alert system described herein that lets a child alert their parents you that they are in trouble by simply shaking their phone rapidly for a set period of time (such as 10 seconds).

Optionally additional features allow parents to know where children are and where they have been; who children are talking with; what children are texting about; whether children are traveling at safe speeds or texting while driving.

SafetyFirst™ addresses parents worry about whether children are safe when they are out, or wondering where they are or concerned that children aren't where they say they are going to be or are in unsafe places. Optionally, according to specific embodiments of the invention, SafetyFirst lets parents know that children are calling or chatting with people who may put them at risk.

According to specific embodiments of the invention, the service is easy to use. Parents can register for a secured SafetyFirst account using any web browser. Then, with a few mouse clicks, they can get the answers to the above-discussed questions, giving peace of mind and a greater sense of security when it comes to children.

According to specific embodiments, the invention allows parents to choose the level of tracking and logging that is desired or appropriate. Each phone can have its own set of features enabled or disabled by the parent. The service tells parents where children are, how long they have been there, and where they have been, in case they become lost or missing. The service also tells parents if children are hanging out in places where they might be in danger. It allows parents to easily learn whom children are calling and who is calling them so parents can call around if children are not where they are expected to be. The invention can also tell parents who children are texting, who is texting them, and what is being said that might harm them. The invention can also alert parents if children are in danger by driving too fast, driving while on the phone without using a headset, or texting while driving. It also reveals the last known location of children's cell phone in case their phone is lost or stolen. In further embodiments, the service can indicate if a children's phone was turned off on purpose or if their battery just died.

According to specific embodiments of the invention, the SafetyFirst Service may be a subscription service or may be provided as an adjunct to other mobile services.

### Shake Detection Example Implementation

In one example embodiment, shake detection functionality is implemented in the single class called ShakeDetector. This class implements all the logic of working with sensor and serves as abstraction layer from hardware. It also implements notification processing logic. It gets notifications detects events; analyzes events sequences; notifies subscribing class about shakes detected. The listening itself is done by an anonymous inner class that implements SensorEventListener and listens to events from Acceleration sensor.

In order to use the technology, an application developer should decide which class will implement logic of what to do on shake event series being detected. 1. Make this class implementing ShakeNotificationListener interface. Instantiate instance of ShakeDetector. Call startListening and pass instance of your class (shake series event handler) as parameter.

### Example Detection Logic:

According to specific embodiments of the invention, events coming from a “NotificationService” of a smartphone or similar device generally contain acceleration values in three dimensions along three orthogonal axises, e.g., x, y and z. Generally, acceleration detection also includes gravity, which allows the phone to determine. Thus acceleration in many implementations would be equal 0 by all axises only when the phone is in the state of free fall. When the phone is stationary or placed on a stationary surface, the acceleration sensors generally detect gravity force.

According to specific embodiments of the invention, the three constants that control shake series detection are as listed below. These constants can be adjusted in specific implementations as needed:
Detectable shake series length (default: 5 seconds=5000):

private static final int SENSITIVITY_MS_FOR_SHAKING_EVENT=5000;
Delay between shake events to start counting series from scratch (default: 1 second=5000):

private static final int SENSITIVITY_MS_TO_BREAK_CYCLE=1000;

Sum of absolute accelerations across 3 modules which stands as a lower limit for shake event, in other words: if (|x|+|y|+|z|>SENSITIVITY_SUM_ABSOLUTE_ACCELERATIONS)=>Shake event. This formula can be made more advanced in specific embodiments, but this can require more arithmetic operations and CPU. Experiments have shown that the sum of absolute values serves well for detecting series of shakes at defined intervals, such as 2, 3, 4, 5 or other number of seconds long.
private static final int SENSITIVITY_SUM_ABSOLUTE_ACCELERATIONS=18;

Sensor sensitivity setting can be changed so that ShakeDetector will get more events from AcceleratorService per second. More events generally lead to better discretion of listening shakes but higher CPU & power consumption.

FIG. 3 illustrates an example graphical user interface showing an example of registering a phone with a server over a website according to specific embodiments of the invention. FIG. 3 illustrates, for example, the display of a Web page on a personal computer, tablet computer, or smartphone. According to specific implementations and/or embodiments of the present invention, this example Web page was sent from the server system to the client system when a user accessed the server system.

FIG. 4 is a diagram illustrating an elderly user employing a shake alert motion according to specific embodiments of the present invention. As further described herein, such a shake can be detected based on duration of the shake. The shake may also be detected based on vigorousness or other motion of the shake or by a user holding down a finger on any part of a screen or other button on a device during a shake.

### Embodiment in a Programmed Information Appliance

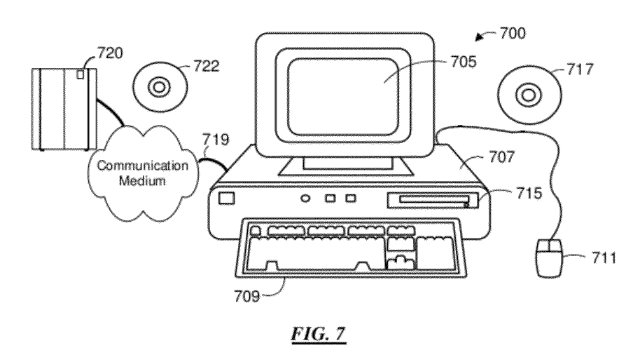

FIG. 7 is a block diagram showing a representative example logic device in which various aspects of the present invention may be embodied, in particular aspects related to registering or deploying an emergency alert server. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a user's computer or a fixed media containing logic instructions may reside on a remote server that a user accesses through a communication medium in order to download a program component.

FIG. 7 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

### Other Embodiments

The invention has now been described with reference to specific embodiments. Other embodiments will be apparent to those of skill in the art. In particular, a user digital information appliance has generally been illustrated as a cell phone or tablet or personal computer. However, the digital computing device is meant to be any information appliance for interacting with a remote data application, and could include such devices as a digitally enabled television, cell phone, personal digital assistant, network enabled digital badge or card or key fob or watch or bracelet, laboratory or manufacturing equipment, etc. It is understood that the examples and embodiments described herein are for illustrative purposes and that various modifications or changes in light thereof will be suggested by the teachings herein to persons skilled in the art and are to be included within the spirit and purview of this application and scope of the claims.

The general structure and techniques, and more specific embodiments that can be used to effect different ways of carrying out the more general goals are described herein.

Although only a few embodiments have been disclosed in detail above, other embodiments are possible and the inventor (s) intend these to be encompassed within this specification. The specification describes specific examples to accomplish a more general goal that may be accomplished in another way. This disclosure is intended to be exemplary, and the claims are intended to cover any modification or alternative that might be predictable to a person having ordinary skill in the art. For example, while smart phones are described in the embodiments, other embodiments may use other kinds of portable devices with communication capabilities and motion detection. For example, a card or key-fob type device having some communication and motion detection capabilities can be placed in a wallet, worn around the neck, placed in a purse, etc.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer and the portable device may also be a handheld computer, such as a PDA, cellphone, or laptop, running any available operating system, including Android, Windows Mobile, iOS, etc.

The programs may be written in C, Python, Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

Thus, specific compositions and methods of METHOD AND APPARATUS TO TAKE EMERGENCY ACTIONS WHEN A DEVICE IS SHAKEN RAPIDLY BY ITS USER have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A system for providing emergency alerts comprising:
a software application or logic module configured to execute on a portable device and configured to detect shaking or some other deliberate movement by a user of the portable device using an accelerometer or other motion detection mechanism of the portable device;
a software application or logic module configured to, in response to the detecting, initiate one or more logic instructions to cause the portable device to communicate to an emergency server or a different portable device;
wherein the portable device comprises at least one logic processor, at least one memory for storing logic commands, at least one communication interface configured to communicate with one or more communications networks, and at least one accelerometer or other motion detector.

2. The system of claim 1 further comprising:
at said device, the software application or logic module configured to in response to said detecting, initiate one or more actions of the device, said actions comprising one or more of:
turning on an audio receiver or recorder of the portable device;
turning on a camera of the portable device and taking and transmitting video images using the portable device;
turning on a positioning system of the portable device and transmitting the location of the device; and
activating a light or sound of the portable device.

3-4. (canceled)

5. The system of claim 1 further comprising:
at said device, the software application or logic module configured to detect shaking a user input or both while the portable device is in an off or locked or screen locked or inactive state or on state.

6. The system of claim 1 further comprising:
a software application or logic module configured to determine if a detecting is not an emergency request;
a software application or logic module configured to, when the device is on, execute an event listening process inside the device to listen for a shake event; and
a software application or logic module configured to determine the device's battery level and adjust one or more actions.

7-8. (canceled)

9. The system of claim 1 further comprising:
a software application or logic module configured to, in response to the detecting, do one or more of:
initiate one or more logic instructions to power on or wake up one or more services of the device to make external emergency communications; and
direct the device to transmit a message containing information comprising one or more of: name and phone number of the device, location of the device, battery level of the device, and capabilities of the device.

10. (canceled)

11. The system of claim 1 further comprising:
a server software application or logic module configured to operate on a server system and thereby execute an emergency server configured to receive emergency alerts and to take one or more appropriate actions to respond to a potential emergency indicated by the portable device.

12. The system of claim 11 further wherein the server software application or logic module is configured to receive an alert message from a particular device and to examine a stored rules table for that device that defines actions for the server to take and is configured to take the defined actions in the rules table.

13. The system of claim 12 further wherein:
the server actions comprise one or more actions from the group:
calling the police;
emailing a list of people with the date and time and location of the device; and
sending a response message back to the device asking the device to call a certain phone number or to turn on the device's microphone to record ambient sound.

14. (canceled)

15. The system of claim 1 further wherein the device comprises a smart phone; and
further comprising a mobile operating system.

16. (canceled)

17. The system of claim 1 further comprising:
a software application or logic module configured to enable the server or the device to determine which events to respond to or which actions to take in response to detecting an event using one or more of:
metadata from said spatial applications;
a location determined by a sensed device location;
a location area determined by a user interface;
a time of day or day of week;
one or more running other applications;
user input data;
movement information determined by a sensed device location;
ambient sound information determined by a sensed device location;
ambient light information determined by a sensed device location;
an emergency or other condition information received from institutional servers;
individual information received from one or more permitted contacts of a user;
group, community, shopping, promotional, entertainment, or other information received from one or more permitted sources;

18. An alert information system in an information device of a type that comprises software application storage, a processor for executing software applications, a communication interface to one or more communications networks, said system comprising:
at least one motion or user action detector;
an application or logic module for detecting a user action of the telephone or device using the detector;
and in response to said detecting, initiating one or more logic instructions for communicating to an emergency server and/or a different mobile telephone or other portable device;
an emergency server for receiving emergency alerts and taking one or more appropriate actions to respond to a potential emergency.

19. The system of claim 18 further comprising:
at said device, the application in response to said detecting, initiating one or more actions of the device, said actions comprising one or more of:
turning on an audio receiver and/or recorder;
turning on a camera and taking and transmitting video images;
turning on a positioning system, such as GPS, and transmitting the location of the mobile device, flashing a light, making a sound.

20. The system of claim 18 further comprising:
a logic module for determining if a detecting is not an emergency request;
a logic module for detecting a shaking of the device rapidly back and forth for some number of seconds, wherein this continuous back and forth shaking is detect as lasting over the given number of seconds and this triggers an event;
an event listening process inside the device to listen for the event;
when the event occurs, the listener wakes up and sends a message to an external device, such as a server;
wherein the message contains information such as the name and phone number of the device, the location of the device, its battery level, and its capabilities.

21-31. (canceled)

32. A method for providing an alert service using a mobile telephone or other portable device of a type that comprises at least one accelerometer or other user action detector and is able to communicate with a server on at least one communication channel, said method comprising:
detecting a user action or movement or shaking of the telephone or device using the accelerometer or other motion detection mechanism;
in response to said detecting, initiating one or more logic instructions for communicating to an emergency server or a different mobile telephone or other portable device;
at an emergency server, taking one or more appropriate actions to respond to a potential emergency.

33. The method of claim 32 further comprising:
at said device, in response to said detecting, initiating one or more actions of the device, said actions optionally selected from the group:
turning on an audio receiver and/or recorder;
turning on a camera and taking and transmitting video images;
turning on a positioning system, such as GPS, and transmitting the location of the mobile device, flashing a light, making a sound.

34-36. (canceled)

37. The method of claim 32 further comprising:
establishing an event listening process inside the device to listen for the event and
when the event occurs, the event listening process wakes up and sends a message to an external device, such as a server, wherein the message contains information comprising one or more of: name and phone number of the device, location of the device, battery level of the device, and capabilities of the device.

38-39. (canceled)

40. The method of claim 32 further comprising:
a server receiving the message and examining a rules table that defines actions for the server to take;
the server then taking the defined actions, wherein the defined actions comprise one or more of:
calling the police;
emailing a list of people with the date and time and location of the Smartphone;
sending a response message back to the Smartphone asking the Smartphone to call a certain phone number or to turn on the Smartphone's microphone and recording ambient sound.

41-46. (canceled)

47. The method of claim 32 further comprising adjusting shake detection or an emergency action or both based on one or more of:
a location determined by a sensed device location;
a location area determined by a user interface which allows a user of the system to control location area a time of day or day of week;
one or more running other applications;
user input data;
movement information determined by a sensed device location;
ambient sound information determined by a sensed device location;
ambient light information determined by a sensed device location;
an emergency or other condition information received from institutional servers;
individual information received from one or more permitted contacts of a user.

48-55. (canceled)

56. A computer readable tangible medium containing computer interpretable instructions that when loaded into an appropriately configured information processing device will cause the device to operate in accordance with the system of claim 1.

57. A computer readable tangible medium containing computer interpretable instructions that when loaded into an appropriately configured information processing device will cause the device to operate in accordance with the system of claim 18.

58. (canceled)
